(19) United States
(12) Patent Application Publication
(10) Pub. No.: US 2009/0320021 A1
(43) Pub. Date: Dec. 24, 2009

(54) DIAGNOSIS OF APPLICATION PERFORMANCE PROBLEMS VIA ANALYSIS OF THREAD DEPENDENCIES

(75) Inventors: Aimin Pan, Beijing (CN); Bin Benjamin Zhu, Edina, MN (US); Jiaxin Cao, Hefei (CN); Zituo Li, Beijing (CN); Jiajie Wang, Hefei (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/141,948

(22) Filed: Jun. 19, 2008

(51) Int. Cl. G06F 9/46

(52) U.S. Cl. 718/100

(57) ABSTRACT

A “Performance Evaluator” provides various techniques for tracking system events to diagnose root causes of application performance anomalies. In general, traces of system events involved in inter-thread interactions are collected at application runtime. These traces are then used to construct inter-thread dependency patterns termed “control patterns.” Control patterns are then evaluated to determine root causes of performance anomalies. Where an application terminates abnormally or full traces cannot be collected for some reason, partial control patterns are constructed for that application. In various embodiments, “fingerprints” are then generated from full or partial control patterns and are matched to fingerprints corresponding to operations in other control patterns extracted from reference traces collected on the same or similar systems. Matched fingerprints or control patterns are then used to deduce the root cause of application performance anomalies associated with full or partial traces.

### BACKGROUND

1. Technical Field

A “Performance Evaluator” provides various techniques for capturing and evaluating inter-thread interactions and dependencies in order to determine root causes of performance problems such as execution delays, hangs, or crashes, through a comparison to previously constructed control patterns.

2. Related Art

As is well known to those skilled in the art, modern operating systems often provide various asynchronous communication mechanisms that allow various applications to interact with each other or with other system components. Further, an application-level synchronous operation may contain one or more underlying asynchronous procedures. An asynchronous procedure can may be dispatched to or executed in different threads. Asynchronous and multi-threaded programming can be used to improve responsiveness of applications such as those including a user interface (UI) at the cost of higher complexity.

Synchronous operations (i.e. “blocking calls”) may make a UI program hang for a long period of time if the called function or operation initiates a time-consuming synchronous action or waits for a failure notification or timeout. In such cases, the program's UI appears frozen to the user until the blocking call returns. It is generally inconvenient or very difficult to avoid synchronous operations (i.e. blocking calls) in UI threads. For example, some synchronous operations such as “gethostbyname” have no asynchronous equivalents. Since synchronous operations in UI threads may prevent the threads from responding to the user, UI hangs may result while waiting for the synchronous operation. Further, introduction of additional threads by a synchronous operation can sometime hide the true cause of a hang from the UI thread.

Conventional profiling tools can often effectively reveal time consumption problems (such as UI hangs, for example) of application-level or language-level operations or even machine instructions during the execution of a task. However, such tools do not take control flow information and the relationship among operations into account. Consequently, these types of tools cannot generally deduce the root causes of problems relating to control flow and interaction between operations. Heuristic methods have been used in some cases to identify root causes of such problems, but deep knowledge and skills to deduce the root causes are required.

Several conventional techniques have looked at various types of dependency information to diagnose performance problems. For example, one such technique tracks interactions between components with an application-specific schema, and then applies postmortem analysis for modeling system performance. More specifically, this technique automatically extracts and models a system's workload. It extracts the work flow of an application-level request by monitoring events from the kernel or application components. Then, it correlates the events and analyzes the time and resource consumption for each request. This technique is generally suitable to analyze server-side software and find performance bottlenecks in distributed computing environments. A related technique collects end-to-end traces of a Java Platform request by tagging each call in the call path with a global request ID and propagating the request ID. The goal of this technique is to diagnose faults by applying statistical methods to identify the components that are highly correlated with the failed request.

Another conventional technique uses system call information to deduce process dependencies and then tries to improve the system scheduling to streamline application or operation execution. More specifically, this technique generally uses system call information to deduce process dependencies, and then improves the system scheduling mechanism. It improves the system performance when scheduling a set of processes with dependencies. In particular, this technique acts to solve a priority inversion problem which degraded possible system performance. A related technique deals with soft hangs by performing a static analysis of the source code to identify and reschedule blocking calls in UI threads.

Other conventional techniques track remote procedure call (RPC) messages to construct causal relations among messages and then debug performance problems for distributed systems. More specifically, this technique generally provides an approach to debug performance problems for distributed systems. It passively traces high-level messages, infers the causality of the messages, and constructs causal paths for external requests in a distributed system. Then, the causal paths are used to debug performance issues in the system. A related technique allows arbitrary predicates and actions to be associated with instrumentation points for tracing operational data for use in diagnosing performance problems.

Recently, conventional techniques have begun to address interactive performance (i.e., UI responsiveness) in an attempt to improve user experiences. For example, one conventional technique provides a method to measure interactive performance of a system with latency in various operations. Such metrics are then manually evaluated for use identifying various ways in which application performance could be improved. A related technique uses interrupt and latency metrics to compare the latency performance of driver models on various Windows® platforms. For example, one such technique provides a measurement infrastructure to help diagnose the causes of unexpected long delays based on the collected data from relevant modules. This technique captures application trace data when a user-perceived performance anomaly occurs, and allows experts to manually analyze the trace data in an attempt to determine the root causes of the delay.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In general, a “Performance Evaluator,” as described herein, provides various techniques for using system-level inter-thread dependencies and operation times to construct full or partial control patterns for diagnosing root causes of performance problems or anomalies. A performance anomaly is identified automatically by locating one or more time-consuming operations in particular threads (especially in UI threads, where such problems are more likely to be noticed by the user), or whenever the user manually indicates that a performance problem is suspected. Either case triggers the saving and evaluation of thread trace data, as described in further detail below. Note that a “root cause” of a performance anomaly manifests in one of three forms, including: (1) an operation in a certain thread; (2) an object visible to users or programs; or (3) a set of continuous operations in a particular module or in a particular function.

More specifically, software applications are often coded using various inter-process communication (IPC) mechanisms, either general ones like remote procedure calls (RPC) or custom calls provided by individual software venders. These IPC's are generally built on top of the underlying system mechanisms. System-level dependencies between such calls can be used to analyze various performance issues caused by single threads, or by the interaction of multiple threads or processes. No matter what kinds of IPCs are used by applications, the root causes of performance problems can always be deduced even if those root causes are not directly in an ill-performed thread or process. The Performance Evaluator considers these factors in providing various techniques for determining the source of such root causes.

For example, in various embodiments, the Performance Evaluator tracks system events to diagnose the root causes for performance anomalies in applications or tasks initiated automatically or by user action. System events and inter-thread interactions relating to the task are then recorded to a buffer or trace file as those events occur. “Control patterns” are then extracted from the trace file for the task. Note that a “control pattern” is defined as including the set of critical paths during the period of handling a task, and contains an identification of all participant threads and the causal relations of the operations that happen in those threads. Then, if the task behaves abnormally, the Performance Evaluator evaluates the corresponding control pattern and automatically determines the root causes of the abnormal performance.

In various embodiments, the Performance Evaluator captures inter-thread interactions for a set of benchmarks as well as from real programs. For example, the Performance Evaluator includes a “tracer” that collects data from a live system, and stores that data for later analysis. In general, the tracer operates as a background process or the like that captures and records inter-thread interactions. Thread dependencies are then constructed based on observed causal relations among various system operations, as deduced from the recorded inter-thread interactions. Note that thread dependencies include process dependencies in modern operating systems.

In order to avoid collecting large amounts of irrelevant data, in various embodiments, a temporary circular “trace buffer” is used to temporarily buffer the data collected by the tracer before writing that data to the aforementioned trace file. Then, data in the trace buffer is written to the trace file whenever a performance anomaly occurs (or is manually indicated by the user). Note that the size of the trace buffer can be fixed, set via a user interface, or automatically set based on an evaluation of previously captured data. The data stored in the trace file is then analyzed to extract a “control pattern” for the performance anomaly. In various embodiments, a “fingerprint” is generated from full or partial control patterns. Root causes are then deduced based on a comparison of the control pattern (or control pattern fingerprint) to either subsequently generated control patterns or fingerprints, or to a local or remote database of pre-evaluated control patterns or fingerprints.

Note that it is not necessary to have a full control pattern in order to deduce the root cause of a performance anomaly. For example, when a system exhibits slow or unusual behavior, many users do not have the patience to wait for an ill-performed task to complete. In such cases, the user often manually terminates the task before it completes. The result is that any data captured by the tracer will be incomplete, resulting in a partial or incomplete control pattern. Similarly, in the case that the trace buffer has a limited size, as noted above, the saved trace data may cover only a portion of the anomaly period.

In these cases, the Performance Evaluator cannot directly extract a full control pattern for the task from the trace data. However, the partial data can still be used to identify the root cause of the performance anomaly. For example, in various embodiments, the Performance Evaluator includes the capability to accurately match full or partial operations from different traces. Therefore, the Performance Evaluator can be used to deduce the root causes when only a partial control pattern can be extracted from the current trace data.

In view of the above summary, it is clear that the Performance Evaluator described herein provides various unique techniques for using system-level inter-thread dependencies to construct full or partial control patterns for diagnosing root causes for interactive performance problems. In addition to the just described benefits, other advantages of the Performance Evaluator will become apparent from the detailed description that follows hereinafter when taken in conjunction with the accompanying drawing figures.

### DESCRIPTION OF THE DRAWINGS

The specific features, aspects, and advantages of the claimed subject matter will become better understood with regard to the following description, appended claims, and accompanying drawings where:

FIG. 1 provides an exemplary architectural flow diagram that illustrates program modules for implementing various embodiments of a Performance Evaluator, as described herein.

FIG. 2 illustrates a simple example of a single thread completing a task by itself.

FIG. 3 illustrates a simple example of a first thread completing a task following interaction with a second thread.

FIG. 4 illustrates a simple example of a single thread completing a task following receipt of data from a device in response to an I/O request issued by the single thread.

FIG. 5 illustrates a simple example of a success case in a synchronous I/O operation.

FIG. 6 illustrates a simple example of a failure case in a synchronous I/O operation.

FIG. 7 provides general system flow diagram that illustrates exemplary methods for implementing various embodiments of the Performance Evaluator, as described herein.

FIG. 8 is a general system diagram depicting a simplified general-purpose computing device having simplified computing and I/O capabilities for use in implementing various embodiments of the Performance Evaluator, as described herein.

### DETAILED DESCRIPTION OF THE EMBODIMENTS

In the following description of the embodiments of the claimed subject matter, reference is made to the accompanying drawings, which form a part hereof, and in which is shown by way of illustration specific embodiments in which the claimed subject matter may be practiced. It should be understood that other embodiments may be utilized and structural changes may be made without departing from the scope of the presently claimed subject matter.

1.0 Introduction:

In general, a “Performance Evaluator,” as described herein, provides various techniques for using a “tracer” to record system events and inter-thread interactions and dependencies for one or more running applications. These system-level inter-thread interactions and dependencies are then evaluated to construct full or partial “control patterns.” The Performance Evaluator then uses these control patterns, or “fingerprints” constructed from the full or partial control patterns, for diagnosing root causes of interactive performance problems.

More specifically, the aforementioned “tracer” collects important system events from the interactions among threads for some tracking period and stores them into a trace file, either directly, or via a buffer or fixed or variable length. Since the tracer does not know which threads are potentially involved in an abnormal task, all the events occurring in the tracking period are recorded.

When a performance anomaly is identified, either automatically or manually, a control pattern is then extracted from the recorded trace data for the tracking period. This control pattern includes all the significant activities (also referred to herein as “critical paths”) on both the thread that behaved abnormally and the dependent threads. A control pattern represents the critical paths and causal relations of multiple threads that are expected to cooperate to complete a task. Based on the control pattern, therefore, the time consumption on each of the related threads is analyzed. Then the root causes of a performance anomaly are identified.

1.1 System Overview:

As noted above, the Performance Evaluator provides various techniques for using system-level inter-thread dependencies to construct full or partial control patterns that are evaluated, and/or compared to other control patterns, for diagnosing root causes for application performance problems.

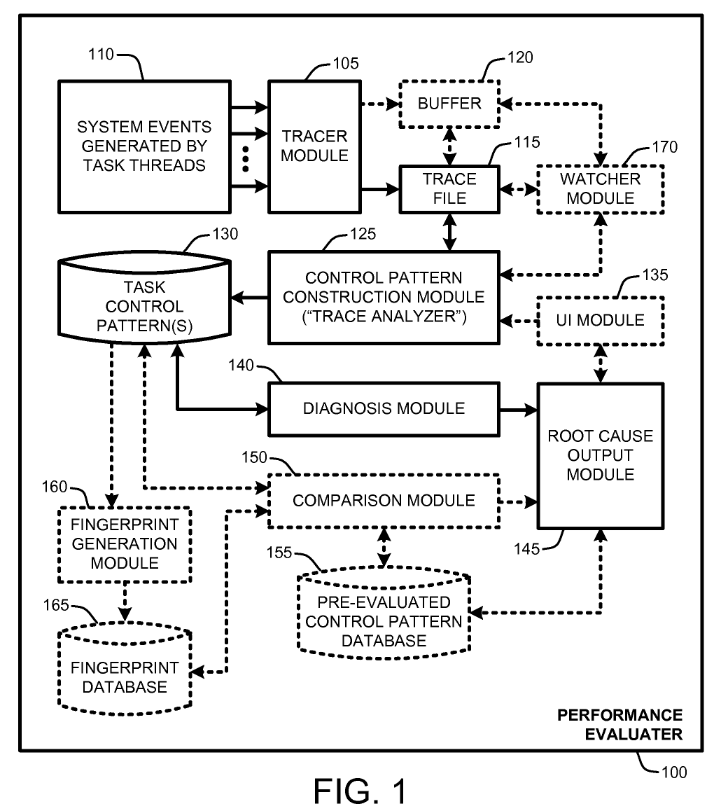

The processes summarized above are illustrated by the general system diagram of FIG. 1. In particular, the system diagram of FIG. 1 illustrates the interrelationships between program modules for implementing various embodiments of the Performance Evaluator, as described herein. Furthermore, while the system diagram of FIG. 1 illustrates a high-level view of various embodiments of the Performance Evaluator, FIG. 1 is not intended to provide an exhaustive or complete illustration of every possible embodiment of the Performance Evaluator as described throughout this document.

In addition, it should be noted that any boxes and interconnections between boxes that are represented by broken or dashed lines in FIG. 1 represent alternate embodiments of the Performance Evaluator described herein, and that any or all of these alternate embodiments, as described below, may be used in combination with other alternate embodiments that are described throughout this document.

In general, as illustrated by FIG. 1, the processes enabled by the Performance Evaluator 100 begin operation by using a tracer module 105 (also referred to herein as a “tracer”) to capture all system events 110 generated by threads associated with individual running tasks. In various embodiments, the system events 110 captured by the tracer module 105 are either written to a trace file 115, or stored in a temporary or circular buffer 120 prior to being written by the trace file.

A control pattern construction module 125 (also referred to herein as a “trace analyzer”) then acts to evaluate the data in the trace file 115 and construct a control pattern whenever a performance anomaly is suspected or manually indicated by a user via an optional UI module 135. In general, as described in further detail in Section 2.4.2, the control pattern includes all the significant activities on both the thread that behaved abnormally and on any dependent threads. As such, the control pattern represents the critical paths and causal relations of multiple threads that cooperate to complete a task. Once the control pattern construction module 125 extracts the control pattern from the trace file, the control pattern is stored to a file or database 130 of task control patterns.

Next, a diagnosis module 140 evaluates the stored control pattern 130 to identify one or more potential root causes of the performance anomaly, as discussed in further detail in Section 2.4.3. Once the diagnosis module 140 has determined the root causes of the performance anomaly, a root cause output module 145 provides the root causes to the user via the UI module 135, or stores the root causes for later use or evaluation.

As is well known, tasks can terminate abnormally for any of a number of reasons, such as by specific user action, program crash, operating system action, or other reason. Consequently, the trace file 115 may not include an entire record of the period during which an anomaly occurred (e.g., the trace file may contain a record of the beginning of the anomaly, but not the end due to the abnormal termination). Similarly, the trace file 115 may not include an entire record of the period during which an anomaly occurred if the trace data is first stored to the buffer 120, and if the size of the buffer is insufficient to contain all trace information for the entire period during which the anomaly occurred. For example, the trace file may contain a record that includes the end of the anomaly, but not the beginning of that anomaly.

In either case, the control pattern construction module 125 still generates and stores a control pattern 130. However, the control pattern 130 will be a “partial control pattern.” The diagnosis module 140 still analyzes these partial control patterns in the same manner as with full control patterns in order to identify one or more root causes of the performance anomaly. However, depending upon how much information is available in the trace file 115, it may not be possible to fully diagnose all root causes of the performance anomaly.

Therefore, in various embodiments, whenever a partial control pattern is extracted from the trace file 115 by the control pattern construction module 125, a comparison module 150 will periodically compare subsequently generated control patterns 130 to the partial control pattern to determine if there is a match between the partial control pattern and a subsequent full (or at least more complete) control pattern. If there is a match, then, assuming that the diagnosis module 140 has already determined the root causes of the performance anomaly of the matched subsequently generated control pattern, the comparison module provides those root causes to the root cause output module 145.

Further, in a related embodiment, whenever the control pattern construction module 125 constructs a partial control pattern, it triggers a watcher module 170 to look for a repeat of the data in the trace file 115 or buffer 120. Then, if the watcher module observes a repeat of the trace data leading to the partial control pattern, it ensures that a more complete record of the period of anomalous behavior is captured. For example, in the case of a circular buffer 120 that is too small to capture the entire anomalous period, the watcher module can either automatically increase the buffer size, or will ensure that the contents of the buffer are written to the trace file 115 before any data is lost due to the limited size of the buffer.

In addition, since various performance anomalies can repeat, or can occur on more than one system, in various embodiments, a database 155 of pre-evaluated control patterns is constructed. In general, this database 155 or pre-evaluated control patterns simply includes full or partial control patterns (or “fingerprints” generated from full or partial control patterns) along with an identification of the root causes associated with those control patterns. In one embodiment, construction of the pre-evaluated control pattern database 155 is accomplished by populating that database with root cause information and corresponding control patterns via the root cause output module 145.

Further, in various embodiments, the pre-evaluated control pattern database 155 is maintained by a remote server, so that multiple clients can report root causes and associated control patterns to the pre-evaluated control pattern database. The pre-evaluated control pattern database 155 can then be accessed by the comparison module 150 for use in locating matching control patterns for comparing locally constructed control patterns 130 to entries in the pre-evaluated control pattern database. Note that in this case, the entire pre-evaluated control pattern database 155 can be provided to the client as a download that is periodically updated by the server, or the client can simply send full or partial control patterns to the server for a remote comparison, with the server then reporting the results back to the client.

Finally, in various embodiments, the Performance Evaluator 100 includes a fingerprint generation module 160 that generates “fingerprints” from control patterns 130, and then stores those fingerprints to a fingerprint database 165. In general, the “fingerprint” of an operation is defined as a summary of code logic for the operation and the thread itself. A fingerprint should be instance-independent, which means that it does not vary with the instances of modules or processes or threads. In one embodiment, the call stack of an operation and the thread function are used to calculate the fingerprint for an operation. All addresses are then normalized to their offsets to the base addresses of the corresponding modules so that they are independent of the module instances.

Fingerprints can then be used by the comparison module 150 in the same manner as for full or partial control patterns 130 to determine whether there is a match to a subsequently generated control pattern, or a match to an entry in the pre-evaluated control pattern database 155. In particular, the “fingerprint” of an operation is defined as a summary of code logic for the operation and the thread itself. A fingerprint should be instance-independent, which means that it does not vary with the instances of modules or processes or threads. In a tested embodiment, of the Performance Evaluator, the call stack of an operation and the thread function were used to calculate the fingerprint for an operation. All addresses were normalized to their offsets to the base addresses of the corresponding modules so that they are independent of the module instances.

2.0 Performance Evaluator Operational Details:

The above-described program modules are employed for implementing various embodiments of the Performance Evaluator. As summarized above, the Performance Evaluator provides various techniques for using system-level inter-thread dependencies to construct full or partial control patterns that are evaluated, and/or compared to other control patterns, for diagnosing root causes for application performance problems.

The following sections provide a detailed discussion of the operation of various embodiments of the Performance Evaluator, and of exemplary methods for implementing the program modules described in Section 1 with respect to FIG. 1. In particular, the following sections describe examples and operational details of various embodiments of the Performance Evaluator, including: an operational overview of the Performance Evaluator; an overview of conventional thread interactions; determining success or failure of an operation; a discussion of the basic functional elements of the Performance Evaluator; examples of pseudo code for implementing the basic functional elements of the Performance Evaluator; and a discussion of an exemplary tested embodiment of the Performance Evaluator.

2.1 Operational Overview:

In general, the Performance Evaluator provides records and evaluates system-level inter-thread dependencies and operation times to construct full or partial control patterns. These control patterns are then used in various embodiments for diagnosing root causes of performance problems or anomalies. For example, in various embodiments, the Performance Evaluator tracks and records system events and inter-thread interactions relating to a task suspected or having anomalous performance. This data is recorded to a buffer or trace file as those events occur. Control patterns are then extracted from the trace file for the task. The Performance Evaluator then evaluates the corresponding control patterns and automatically determines the root causes of the abnormal or anomalous performance.

2.2 Thread Interactions:

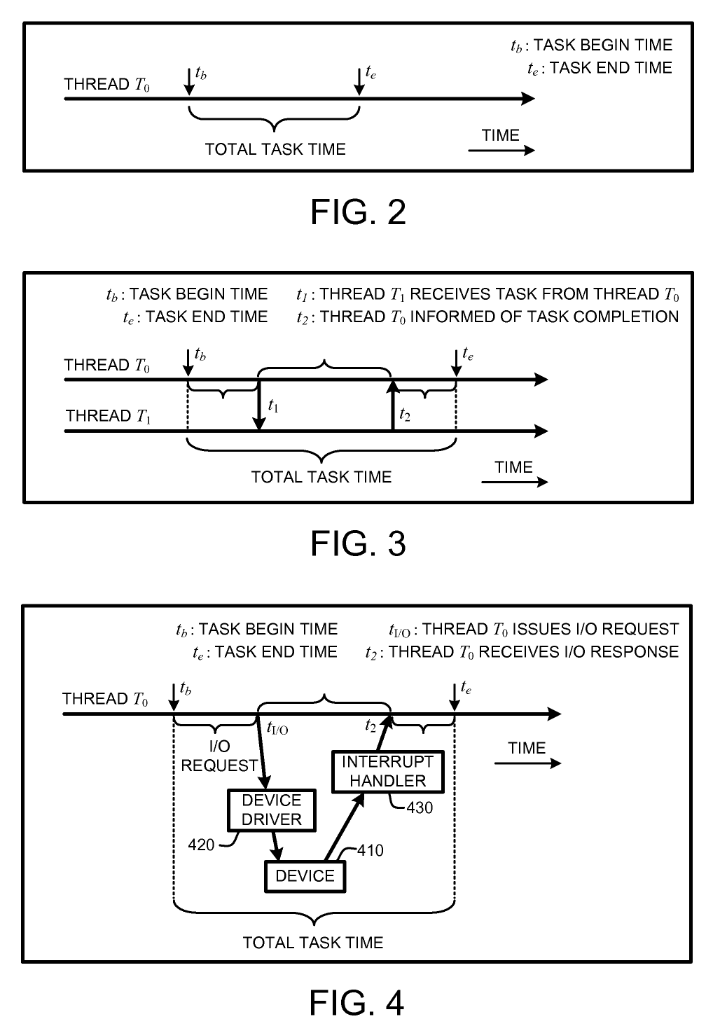

In typically operating systems and applications, multiple threads generally interact or otherwise cooperate to complete a particular task, such as, for example, responding to a user selection of an application “button,” displaying a UI window, printing a document, etc. In the simplest case, the thread receiving a task completes it by itself, as shown in FIG. 2. In this case, the time needed to complete a task (between task begin time, t_{b}, and task end time, tₑ) generally depends on the workload of the task and the priority that the system allocates to the thread, T₀.

However, more than one thread is generally involved in completing a particular task. This occurs frequently in real applications. For example, networking I/Os can be performed with dedicated threads so that user-interface threads interact with the dedicated I/O threads to perform network transmission tasks. An example of a very simple interaction between only two threads is illustrated in FIG. 3 (note that many threads can interact, and that the interaction of only two threads is provided for purposes of explanation). In particular, FIG. 3 illustrates the case where thread T₀ begins a task at time t_{b}. As part of that task, thread T₁ then receives a request from Thread T₀ at t₁. Thread To is then informed at time t₂ that the request has been completed. Finally, thread T₀ completes the task at time tₑ. The way that T₀ informs T₁ of a request can vary. Two methods are typically used:
(1) Thread T₁ is waiting on a synchronization object, and thread T₀ signals that object when it needs thread T₁ to do something; and
(2) Thread T₀ queues a data structure which represents its request, thread T₁ then takes the structure from the queue when it is available.

If the requests issued by thread T₀ are naturally sequential, or if the requests are guaranteed to be sequentially delivered, in the context of thread T₀, then the first method (i.e., synchronization objects) is appropriate. Otherwise, the second method is appropriate (i.e., queued data structures). In the second method, thread T₁ can have different scheduling policies to process the requests in the queue, e.g., by periodically checking the queue or using conventional system mechanisms such as system timers or asynchronous routines to deliver requests.

After thread T₀ issues its request to thread T₁, it can either wait for the request to be completed or continue to perform the remaining task, depending on whether the request can be processed asynchronously or not. When thread T₁ completes the request, it informs thread T₀ of the completion in some way. For example, one straightforward way to inform thread T₀ of completion is to signal thread T₀ with a synchronization object that thread T₀ is waiting for. Another way is to inject a schedulable routine such as a timer procedure or an asynchronous routine into thread T₀'s context.

In addition to interacting with other threads, a thread may interact with a device in order to complete a task, as shown in FIG. 4. For example, in completing a task begun at time t_{b}, if a thread T₀ needs to read data from a disk or network device 410, that thread first sends an I/O request, at time t_{I/O}, to the device. This request is generally sent via either a uniform interface provided by the operating system or an interface specific to the device 410 via a device driver 420. Then, the thread waits for completion or continues to perform the remaining task, depending upon whether the particular I/O operation is synchronous or asynchronous. Once the device 410 informs the thread of its I/O completion, typically via the interrupt handler 430, the interrupt handler releases the wait or calls a completion routine directly or indirectly. If the completion routine has to be called in the context of the original thread, the interrupt handler 430 must schedule an asynchronous routine for the thread via a system mechanism. Note that such thread interactions are well known to those skilled in the art, and will not be described in further detail herein.

In designing conventional software, functionalities are typically decoupled among threads. Interactions between two threads tend to be of the types shown in FIG. 3 and FIG. 4. However, there may be variations when more than two threads participate in a task. For example, thread T₀ asks thread T₁ to do something; T₁ transfers the received request to a third thread, T₂, and T₂ informs T₀ of the completion directly. However, any threads that contribute a significant part in processing a task have two distinct interactions with other threads, one for receiving a request and the other for acknowledging completion of the request. Further, these interactions may involve one or more levels of “causal relations” between threads. In general, “causal relations” are those that can be identified as Lamport's “happened-before” relations among the participant threads for completing a task.

Note that these well known causal or “happened before” relations (represented here by the symbol “→” such that “A→B” means “event A happened before event B”) are generally formally defined as follows:
A→B, if event A and B are within the same process (i.e., within the same sequential thread of control) and event A occurred before event B;
A→B, if event A is the event of sending a message M in one process and event B is the event of receiving M by another process;
if A→B, and B→C, then A→C;
Event A causally affects event B if and only if A→B; and
Distinct events A and B are “concurrent” (i.e., A||B) if neither A→B or B→A.

2.3 Success or Failure of an Operation:

In some cases, the interactions between threads for a successful operation may not be distinguishable from those of failed operations. For a simple blocking call, a failed operation may be indicated by a special return value. For example, a wait operation can be released when its timeout interval expires. The return value can then be used to determine whether a wait is satisfied or not. For an asynchronous operation, however, failure notification is generally more complicated than a special return value. Conventional “timers” often play an important role in this case.

For example, consider a typical I/O failure in which a network client attempts to connect to a server. In general, when the client attempts to connect to the server, a network module sends a connection request to the underlying networking interface, which processes sequential requests. However, network packets may be lost during transmission. In this case, the network hardware will not interrupt any processes to notify of connection failures. Therefore, to address this issue, a typical scheme is to set a “timer” immediately after the network module issues a connection request. The timer is then cancelled if a reply is received before the timeout interval expires. Otherwise, the timer can be used to notify the network module of timeout. Therefore, in the case of a request failure, the notification comes from the timer instead of a network interrupt.

As is well known to those skilled in the art, an operation failure may or may not change the control path of a task, depending upon how the task or application is coded. However, whether an operation succeeds or fails, the part of the control path before the operation should be identical based on the causal order of the operations among the participating threads. On the other hand, the post-processing of a failed operation may vary. For example, if the failed operation is critical to the task, the control is often shifted to outermost of the control flow of the current thread via some kind of conventional error processing. Otherwise, the control may alter based on some predefined logic, or simply continue to perform the remaining task.

It has been observed that the ratio of the time taken by a failed operation to the total time needed for processing a task is typically a useful clue on the significance of the operation to that task. The Performance Evaluator uses such information in various embodiments when evaluating control patterns to determine root causes of performance problems.

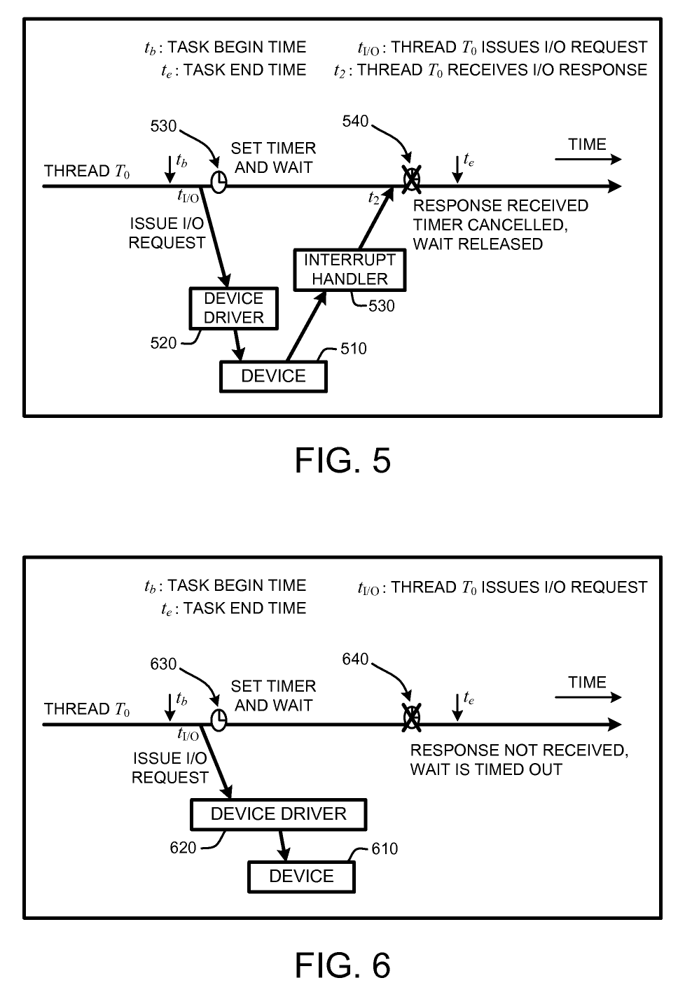

FIG. 5 illustrates a simple example of a conventional synchronous network I/O operation. In particular, in completing a task begun at time t_{b}, thread T₀ sends an I/O request, at time t_{I/O}, to a device 510 via a conventional device driver 520. A conventional wait timer is then set 530. Once the device 510 informs the thread of its I/O completion via an interrupt handler 530, the interrupt handler 530 releases the wait and cancels 540 the timer, or calls a completion routine directly or indirectly.

FIG. 6 illustrates a failure case where the response is not provided before the wait time runs out. In particular, as illustrated in FIG. 6, in attempting to complete a task begun at time t_{b}, thread T₀ sends an I/O request, at time t_{I/O}, to a device 610 via a conventional device driver 620. A conventional wait timer is then set 630. However, unlike the example illustrated in FIG. 5, the device 610 does not inform the thread of its I/O completion via an interrupt handler prior to automatic timeout 640 of the wait timer. Note that conventional network utility “ping” uses a wait timer in this manner, but the wait operation is often hidden in the socket library or other system modules.

2.4 Functional Elements of the Performance Evaluator:

As discussed above with respect to FIG. 1, the Performance Evaluator includes a tracer (i.e., the “tracer module 105) that collects important system events from the interactions among threads and stores them into a buffer, or other computer-readable medium, during some tracking period. In various embodiments, the length of the tracking period is either automatically determined by the Performance Evaluator, limited as a function of buffer size, or set via a user interface. The tracer does not determine whether a problem in thread execution or performance exists or whether a particular task is abnormal, it simply continuously collects and records all the events occurring in the tracking period. Note that in the case of a circular buffer, or the like, the buffer will record data until it is full, then new data will continue to be recorded while the oldest data is dumped from the buffer to make space for the newer data.

Then, when a performance anomaly is identified, either automatically or manually (such as by a user indicating that a delay has been observed in a UI window or the like, the Performance Evaluator extracts a control pattern from the buffered data for the anomaly period (i.e., the tracking period). This control pattern includes all the significant activities on both the thread that behaved abnormally and on any dependent threads. As noted above, a “control pattern” represents the critical paths and causal relations of multiple threads that are expected to cooperate to complete a task. Therefore, by analyzing the time consumption on each of the related threads based on the control pattern, the root causes of a performance anomaly can be identified.

Further, assuming that a particular problem has been observed previously, and that a matching control pattern (or a fingerprint derived from a matching control pattern) has been previously generated, a comparison of the current control pattern to control patterns in a set or database of previously stored control patterns (or fingerprints) can also be used to identify the particular problem.

2.4.1 Collecting Information on a Live System:

Whatever programming interfaces are used in applications in a conventional operating system, inter-process communications are typically done by one of several well-defined primitives, such as semaphore, mutex, critical section, event, or signal. In addition, I/O responses are typically delivered via interrupts or asynchronous procedures. Consequently, using only application-level information is generally insufficient to diagnose application performance problems.

In particular, some system mechanisms such as asynchronous call dispatching and I/O delivery are hidden from an application-level tracer. For example, in the case that an I/O request fails after a certain period of time, the cause cannot necessarily be deduced from the application level since the return status may not accurately specify the exact reason for the failure. In contrast, it is possible to know everything related to the I/O request if a thread-level tracer, such as the one described herein, monitors all interactions between threads in the control path of a task.

Note that in order to resolve a performance problem such as an interactive performance issue, the trace information should be as complete as possible so that indirect culprits will not be missed in the problem diagnosis stage. Therefore, in addition to the system events related to synchronization, registration and delivery of asynchronous procedures should also be captured by the tracer because completion notification and soft timers are often implemented via asynchronous procedures. In addition, I/O requests and I/O completions are also tracked so that they can be associated as a kind of causal relationship. However, as noted above, partial or incomplete control patterns can also be used to identify the root cause of performance problems.

2.4.2 Extracting Control Patterns:

For any particular task, there is a control pattern which consists of one or more control flows (or threads) that cooperate with each other to complete the task. For example, assume that thread T₀ receives a task at time t_{b}, and completes it at time tₑ. The Performance Evaluator first identifies the significant operations during the tracking period (i.e., the period in which data is being recorded). A significant operation is defined as the one whose duration is beyond a fixed or user adjustable threshold, denoted as “T_{THRESHOLD}.” Then the Performance Evaluator searches “causal operations” for each significant operation. This search process is applied recursively until no further significant operations can be found.

Note that a causal operation may be a transient operation which completes immediately. In this case, the tracer records their occurrences instead of their beginning and end events. Then, when searching for significant operations, transient operations are ignored by the Performance Evaluator. Note that a transient operation can be a causal operation of durable operations. For example, release operations are transient, but wait operations are durable. The causal operation of a wait operation is a release operation. If a transient operation is executed in an asynchronous procedure, its causal operation is defined as the procedure unless it has another well-defined causal relation.

In this way, significant operations and their causal operations can be iteratively searched. The aforementioned “control pattern” is then constructed from the causal operations covering the anomaly period. Further, in various embodiments, the operations in the control pattern are stored for further analysis.

Note that the causal relations are system specific. Consequently, the same application running on different types of computers or using different operating systems will generally have different patterns of causal operations, and thus different control patterns. Therefore, in order to make valid comparisons between particular control patterns, those patterns should be made for applications running on similar computers (though not necessarily identical) and similar operating systems (though not necessarily identical).

2.4.3 Diagnosing Root Causes Based on Control Patterns:

In general, a control pattern represents the interactions between a thread T₀, and its dependent threads during a given time period that may or may not span the entire task time, [t_{b}, tₑ]. Since each operation in the control pattern has a timestamp, it is easy to calculate the time consumption for each operation. Based on the causal relations and time consumptions, a “diagnoser” of the Performance Evaluator (see the “diagnosis module 140” in FIG. 1) can deduce a root cause as the specific operation which causes the largest portion of an anomalous delay that results in a performance problem. Note that a particular problem may have more than one root cause. Therefore, the diagnoser of the Performance Evaluator can identify an additional root cause of the performance problem as the operation which causes the second largest portion of the delay (assuming the time consumption of this second “delay” is still significant for the entire period (i.e., that it exceeds the T_{THRESHOLD} time). This procedure can be repeated until no more significant operations exceed the T_{THRESHOLD} time in order to identify all of the potential root causes.

In tested embodiments of the Performance Evaluator, it has been observed that examining context information, such as, for example, the call stacks on time-consuming operations, can be useful for identifying or further probing root causes. For example, a software developer or programmer generally knows which modules and which functions trigger long duration operations either synchronously or asynchronously. However, the developer or programmer may unintentionally make a blocking call in a particular thread, or asynchronously trigger an I/O request where the completion comes later than the expected time. Therefore, the ability to examine information such as call stacks in such cases can help to quickly identify the root causes of the performance problem. In addition to call stacks, other information such as naming information is also helpful, since the naming information often indicates which objects are accessed during the tracking period.

It should be noted that not all performance anomalies can be directly resolved by examining control patterns. For example, in one test case, an application was observed that required more than one minute before a user was allowed to interact with its user interfaces when that application was first started. This delay was considered to represent a performance problem in that the user was unable to interact with the application for more than a full minute.

In evaluating the data captured by the tracer for this application, it was observed that there were no significant “operations” during the tracking period (which in this case was set to cover the time from application startup until the application first allowed user input) when T_{THRESHOLD} was set to more than 100 milliseconds. However, a large number of I/O operations were observed during the tracking period. These I/O operations were included into the control pattern if T_{THRESHOLD} was set to be very small (on the order of about 20 ms). In this case, a simple manual analysis can easily tell that the application was scanning its local cache to fill its user interface elements. Although the diagnoser will not directly identify the root causes in this case, the control patterns extracted from the recorded data by adjusting the T_{THRESHOLD} level to an appropriate value are still useful for diagnosing the root causes. Consequently, it should be clear that the control patterns described herein are useful for a number of purposes, even in the case that the control patterns cannot be used to directly identify the root causes of a performance problem.

2.5 Exemplary Pseudo Code:

The following paragraphs provides various examples of pseudo code for implementing various features of the Performance Evaluator, including: an exemplary data structure for storing trace data captured by the tracer; generation of control patterns from the trace data; diagnosing root causes from control patterns, and diagnosing root causes from partial control patterns.

2.5.1 Exemplary Data Structure for Storing Trace Data:

Durable system operations such as wait operations or asynchronous procedures have two associative data objects, one for the beginning point and the other for the end-point of a durable operation. One simple example of a data structure for storing this information is illustrated in the pseudo code shown below in Table 1. This exemplary data structure is referred to herein as “OPinfo.”

TABLE 1
Pseudo Code for “OPInfo” Data Structure

```
struct OPInfo{
    int pairID;
    int type;
    DWORD timestamp;
    DWORD threadID;
    DWORD processID;
    OPInfo *pairOP;
    OPInfo *causalOP;
    DWORD depthOfCallStack;
    DWORD callStack[STACK_MAX_DEPTH];
    bool isRootCauseOP;  /* marked as a root cause */
    DWORD responsiblePeriod;  /* the period responsible for */
    union OPData;  /* the data specific for various operations */
};
```

In the pseudo code shown in Table 1, “DWORD” is a C type for 32-bit integers and “OPData” is C union type for various kinds of operations. The Performance Evaluator maintains a list of “OPinfo” objects for each of the threads that have activities being recorded in the trace file. “OPinfo” structures for various operations are filled when a trace file is parsed. In particular, the field “pairOP” points to the peer “OPInfo” object that belongs to the same durable operation; and the field “causalOP” stands for the direct causal operation of an operation.

2.5.2 Generation of Control Patterns:

By definition, a “control pattern” is a collection of significant operations and their causal operations for a task on a thread. Significant operations are searched starting from the task thread in the given time period. As noted above, the search then iteratively navigates to the dependent threads if causal relations indicate these threads are also involved in the task processing. Given that the above-described “OPinfo” structure contains the causal relation between an operation and its immediate causal one, the Performance Evaluator can use a recursive process to effectively construct a control pattern for a period on a thread. Table 2 provides pseudo code which illustrates one simple way in which this recursive process can be implemented.

TABLE 2
Pseudo Code for Recursive Construction of Control Patterns

```
  OPArray *g_CPResult;
  extern DWORD g_Threshold;  /* i.e. the threshold T_{THRESHOLD} */
  /* note that g_CPResult should be emptied before calling the function.
*/
  void Generate_CP(DWORD threadID,
        DWORD startTime, DWORD endTime)
  {
    OPList *threadOPList = GetOPsByThreadID(threadID);
    OPList *opList = threadOPList->Sublist(startTime, endTime);
    OPArray *indirectOPs =
      FindIndirectCauseOPs(opList, startTime, endTime);
    for(int i =0; i < indirectOPs ->size( ); i++) {
      DWORD respTime = CalculateResponsibleTime(indirectOPs[i]);
      OPInfo *directOP=FindDirectCauseOP(indirectOPs[i],respTime);
      Generate_CP(directOP->threadID, startTime,
        directOP->timestamp);
    }
  }
  OPArray* FindIndirectCauseOPs(OPList* theOPList,
    DWORD startTime, DWORD endTime)
  {
    OPArray *ops = AllocateOPArray( );
    DWORD startParseTime = startTime;
    OPInfo *startOP = theOPList ->GetFirstOP( );
    OPInfo *endOP = theOPList ->GetLastOP( );
    OPInfo*threadCreatorOP=GetThreadCreator(endOP->threadID);
    OPInfo* threadFirstOP = GetThreadFirstOP(endOP->threadID);
    if (threadCreatorOP != NULL
      && threadFirstOP->timestamp >= startTime)
    {
      ops.Add(startOP);
      startParseTime = startOP->timestamp;
    }
    OPList *parseOPList
        = theOPList->Sublist(startParseTime, endTime);
    for(OPInfo* op = parseOPList->GetFirstOP( ); op != NULL;
      op = parseOPList->GetNextOP( ))
    {
      if (op->type == OP_WAIT_END) /* currently only wait */
                        /*operations are concerned.*/
        if (op->pairOP == NULL
          ||op->pairOP->timestamp-op->timestamp > g_Threshold)
            ops.Add(op);
    }
    return ops;
  }
  OPInfo* FindDirectCauseOP(OPInfo *theOP, DWORD respTime)
  {
    OPInfo* op = theOP;
    theOP->isRootCauseOP = false;
    g_CPResult.Add(theOP);
    while(op->causalOP != NULL) {
      op = op->causalOP;
      op->isRootCauseOP = false;
      g_CPResult.Add(op);
    }
    op->isRootCauseOP = true;  /* overwrite the initial value! */
    op->responsiblePeriod = respTime;
    return op;
}
```

In the pseudo code illustrated in Table 2, “OPList” and “OPArray” are types that offer the semantics of double-link list and array, respectively. Further, “FindindirectCauseOPs” is used to search an “OPinfo list” (see Table 1) for significant operations for a thread in the period specified by the parameters “startTime” and “endTime.” If the thread is newly created in the period, its first operation whose causal operation is a thread creation operation is also a significant one. For other operations, wait operations whose durations are beyond T_{THRESHOLD}, are considered as significant ones, and put into the result array.

Further, the procedure, “FindDirectCauseOP” in Table 2 iteratively probes the direct causal operation for significant operations until no more causal operations can be found. All the causal operations, including the original and intermediate operations, are then put into an “operation collection.” The deepest causal operation in this collection is marked as the root cause for the original operation, with the “isRootCauseOP” field set to true. The “OPinfo” field “responsiblePeriod” is then calculated to indicate the period that the root cause is responsible for. Finally, “Generate_CP” is a procedure that is used to identify significant operations in the period on a thread (also called indirect causal operation in the pseudo code of Table 2) and their direct causal operations, and then recursively calls itself for each causal operation.

2.5.3 Diagnosis of Root Causes:

As noted above, the control pattern for the tracking period on a thread includes the operations that are responsible for the time consumptions (over threshold T_{THRESHOLD}) in the period on the original thread or dependent threads. The searching process for root causes is similar to that of constructing the control pattern. For simplicity, the Performance Evaluator reuses the recursive framework of the control pattern generation pseudo code illustrated in Table 1, and marks the potential root causes during the recursive process. Therefore, the root cause diagnosis based on a control pattern is performed by extracting the root causal operations from the collection of operations in the control pattern, and then sorting them in the order of their responsible periods. Pseudo code illustrating this embodiment is provided in Table 3.

TABLE 3
Pseudo Code for Recursive Construction of Control Patterns

```
  OPArray *g_RCResult;
  void Diagnose_RC(OPArray *theCP)
  {
    for(OPInfo* op = theCP->GetFirstOP( ); op != NULL;
  op = theCP->GetNextOP( ))
    {
      if(op->isRootCauseOP)
        g_RCResult.Add(op);
    }
    SortOPArray(g_RCResult, lessByResponsiblePeriod/* a function*/);
    return;
  }
  void Output_RC(OPArray *theRC)
  {
    if (theRC.size( ) ==0) {
      Print(“Sorry, no root cause found!”); return;
    }
    for(int i=0; i < theRC.size( ); i++) {
      Print(OPName(theRC[i]->type));
      Print(“ at time %d, responsible for time %d”,
  theRC[i]->timestamp, theRC[i]->resposiblePeriod);
      PrintCallttack(theRC[i]);
      PrintOPSpecialInfo(theRC[i]);/*the info like object names, etc.*/
    }
    return;
}
```

As can be seen from Table 3, generation of the control pattern uses the parameters of a thread identifier and a time slot as its input. In one embodiment, these parameters are automatically detected, e.g., a message handler spends more time than a threshold time value in handling a message. In another embodiment, these parameters are manually specified by the user in some way.

2.5.4 Root Causes from Partial Trace Data and Reference Traces:

The embodiments described in Section 2.5.3 work well for a trace that covers the entire anomaly period. However, as noted above, the trace can be partial (i.e., it does not fully cover the anomaly period) for a number of reasons, such as abnormal termination of the application, for example. Further, as noted above, in some cases, performance anomalies may last long enough that the buffer (assuming a fixed size circular buffer) cannot hold all of the trace data. Another possibility is that the user may simply abort or terminate the program, assuming that it has hung or crashed. In each of these cases, the result is the same—the trace data contains only a portion of the system activities that occurred during the anomaly period.

Clearly, when complete trace data is not available, only a partial control pattern can be extracted from the trace data. This partial control pattern may not tell the root cause of a performance anomaly. In this case, the tracer treats subsequently collected traces as “reference traces.” Control patterns from the references traces are compared with the partial control pattern to deduce the root cause of the performance anomaly for which only partial trace data has been collected. Then, if the same performance anomaly occurs subsequently, a match to a subsequently generated control pattern may be sufficient to identify the root causes of the performance anomaly.

Note that in related embodiments, a pre-evaluated database of full and/or partial control patterns (see database 155 in FIG. 1) is created for specific computer type and operating system combinations, along with information regarding the root causes of the performance anomalies corresponding to the control patterns stored in that database. Note that this pre-evaluated database can include either or both automatically evaluated control patterns, as described herein, or manually evaluated control patterns. Then, whenever a full or partial control pattern is constructed for a given reference trace, the Performance Evaluator first compares the control pattern against entries in the pre-evaluated database to see if a match exists. If a match exists, the performance anomaly can be identified without needing to perform further analysis.

Note that in various embodiments, the pre-evaluated database of control patterns can be provided to local computers running the Performance Evaluator, or can be located on a remote server that a local client contacts whenever a control pattern is constructed by the local client. Therefore, by using the database of previously evaluated control patterns, local users can quickly identify the exact root causes of a particular performance anomaly, along with possible solutions that can be included in the database, if desired.

For example, when the trace analyzer (see the control pattern construction module 125 in FIG. 1) detects that the trace data do not cover the entire anomaly period, it extracts a partial control pattern from the trace data using the same techniques as described above with respect to complete control patterns. The Performance Evaluator then sends a request to the tracer that includes the partial control pattern, or fingerprints of the operations in the partial pattern.

When the tracer receives the request, it starts a watcher (see the watcher module 170 in FIG. 1) and enters a monitoring mode. The watcher checks each operation before being sent to the circular buffer. If there is any match of operations with the fingerprints from the partial control pattern, the tracer saves the circular buffer into the disk before the first matched operation is removed from the circular buffer. Therefore, one reference trace file may contain multiple operations specified in the request from the analyzer. The tracer will continue to watch the subsequent operations until there is an exact match with all the fingerprint operations in the partial control pattern or the tracer is instructed to exit the monitoring mode.

Once the analyzer receives the reference traces, it locates the same operations as in the partial control pattern and tries to deduce the missing parts. The reason that the techniques described with respect to partial traces works well is due to the fact that a sequence of operations tends to eventually recur, and causal relations or inter-thread interactions are relatively consistent. For example, in a tested embodiment of the Performance Evaluator, experimental results show that more than 80% of wait operations are released at one or two sites in the control flows of a program. The intuition is that a user tends to repeat a task. The same code logic on the relevant control flows would therefore be likely to be executed again, which is recorded in the reference traces.

2.6 Exemplary Tested Embodiments of the Performance Evaluator:

In a tested embodiment, the Performance Evaluator was implemented on a Windows® operating system platform. In particular, in this tested embodiment, the tracer of the Performance Evaluator was initiated by dynamically instrumenting a set of kernel functions (on the order of about 30 functions) to record system events. In particular, the Performance Evaluator first used the symbol information provided by the well known Microsoft Windows® symbol server to automatically identify the addresses of the functions to be instrumented so that the aforementioned tracer could collect trace data. The Performance Evaluator then automatically instrumented the set of kernel functions via a kernel driver to record corresponding events into a pre-allocated kernel buffer.

In addition to the kernel driver, the tracer runs a user-mode part to periodically retrieve the recorded events from the kernel buffer into a circular buffer. Note that in this tested embodiment, the kernel buffer is allocated from a non-paged memory pool. This allowed the kernel buffer to be accessed when the current IQRL (Interrupt Request Level) was higher than or equal to the Dispatch level. Note that the size of this buffer should be large enough to store the events for the periodic interval such that no events will be missed before the user-mode part of the tracer retrieves them. In the tested embodiment, a buffer size on the order of about 5 MByte in size, was found to provide a sufficiently large buffer for recording the events in the period of 0.5 second on a 3.0 GHz dual-core CPU based PC-type computer running the Windows® operating system.

In another tested embodiment, the Performance Evaluator collects data via a system-supplied instrumentation called ETW (Event Tracing for Windows®). ETW provides both system-level and application-level events for its consumers. The tracer of the Performance Evaluator acts as an ETW consumer, and it selects the system events that are related to inter-thread interactions as its input, and deduces the dependencies between threads from ETW events when the dependencies are not directly available.

2.6.1 Primary Thread Dependencies:

In addition to the functions of manipulating conventional synchronization objects like Semaphore and Mutex, the tested embodiment of the Performance Evaluator tracks asynchronous inter-thread communication mechanisms and associates the insertion and delivery of various asynchronous procedures. On the Windows® platform, there are several types of asynchronous procedures. These procedures include Deferred Procedure Calls (DPCs), which represent interrupts and are irrelevant to any thread; Asynchronous Procedure Calls (APCs), which are executed in the context of a specified thread; and Workitems, which are executed in the context of a system thread. Since all these asynchronous procedures live in system space, their insertions and deliveries can be associated by their addresses.

The I/O manager in the Windows® kernel is also a dispatcher for various I/O requests to either real devices or virtual ones. The tested embodiment of the Performance Evaluator uses I/O Request Packages (IRPs) to associate the occurrences of I/O requests and their completions. Moreover, the spawning and termination of processes and threads are also tracked by the Performance Evaluator so that the actions that are done in new threads or processes are associated with their creators.

Table 4 summarizes the categories of system events that are captured in the tested embodiment of the Performance Evaluator. The “Association” column in Table 4 shows what the relations are based on. A determination of the hooked kernel functions was made using well known standard reference documents, including Windows® Research Kernel (WRK) code and the Windows® Driver Kit (WDK) documentation. Note that this information could also have been extracted directly from the Windows® source code, however, it was a simpler process to simply retrieve the necessary information from the standard documentation.

TABLE 4
Categories of System Events.

| Categories | Association | Main Hooked Functions |
|---|---|---|
| Wait | The addresses of the | KeWaitForSingleObject, |
| | waited object(s) | KeWaitForMultipleObjects |
| Semaphore | The addresses of | KeReleaseSemaphore |
| | semaphore objects | |
| Mutex | The addresses of | KeReleaseMutant |
| | mutant (mutex) | |
| | objects | |
| Event | The addresses of | KeSetEvent, KeResetEvent |
| | Event objects | KeSetEventBoostPriority |
| Timer | The addresses of the | KeSetTimerEx, KeCancelTimer, and the |
| | timer procedures | Timer procedures |
| Async | The addresses of the | KeInsertQueueApc, KeInsertQueueDpc, |
| Procedures | APCs, DPCs and | ExQueueWorkItem, and the async |
| | WorkItems | procedures |
| Thread/ | The addresses of | PspCreateThread, PspExitThread, |
| Process | thread or process data structures | PspCreateProcess, and PspExitProcess |
| I/O requests | The addresses of | IopfCallDriver, and IopfCompleteRequest |
| | IRPs | |
| File | none | NtReadFile, NtWriteFile, IopCreateFile, |
| | | NtDeviceIoControlFile |
| Others | None | KeDelayExecutionThread |

The primary thread dependencies are parsed directly when the analyzer of the Performance Evaluator reads a trace file. The pairOP field in OPInfo structure (see Section 2.5.1 and Table 1) is used for durable operations. In Table 4, wait operations, async procedures, I/O completion, file operations, and KeDelayExecutionThread are all durable. The tested embodiment of the Performance Evaluator records two individual entries for each of them, and uses a 16-bit identifier to associate the two entries. Therefore, the pair relationship of operations is easily built up when parsing a trace file. The causalOP field in OPInfo structure (see Section 2.5.1 and Table 1) is built with the knowledge of associations listed in Table 4.

In addition to these associations listed above, a release operation will be associated with an async procedure if it occurs in the async procedure. Further, an I/O completion operation (IopfCompleteRequest) is associated with both an I/O request (IopfCallDriver) operation and an async procedure if the completion occurs in the async procedure. Additionally, creation of a process or thread is associated with the first operation of the process or thread. Finally, exit of a process or thread is associated with the wait operations for the process or thread. Note that in the tested embodiment of the Performance Evaluator, file operations do not participate in constructing thread dependencies. However, file operations can be considered if desired.

Note that waitable objects in Windows® include not only synchronization objects like mutex and semaphore, but also many other kinds of objects, such as file objects, executive resource, etc. Clearly, all of the objects can be tracked by applying the appropriate information for use by the tracer. Consequently, it should be understood that the object and associations listed in Table 4 are not intended to represent an exhaustive list of the tracing capabilities of the Performance Evaluator, and that the contents of Table 4 are provided only for purposes of explanation.

2.6.2 Operation Matching:

Operation matching is a useful and important capability when available information is not enough to deduce the root causes for a problematic operation. In fact, the root cause deduction when only a partial trace (and thus a partial control pattern) is available depends heavily on the operation matching. In addition to partial pattern deduction, operation matching can also be used for manually analyzing some special wait operations and calculating the distribution of wait operations from a trace.

In the tested embodiment of the Performance Evaluator, operation matching was done by comparing the fingerprints of two operations of the same type. If their fingerprints match, the two operations are said to be identical. In the tested embodiment, the fingerprints were calculated based on the call stack of an operation and the start address of the thread where the operation is executed. Table 5 provides an example of pseudo code for implementing calculation of the fingerprint of an operation.

TABLE 5
Pseudo Code for Calculation of a Fingerprint.

```
DWORD Calculate_FP(OPIn *theOP)
{
  DWORD fpResult = 0, dwValue;
  for(int i = 0; i < theOP->depthOfCallStack; i++)
  {
    dwValue = ModuleOffset(theOP->callStack[i]);
    fpResult \hat{ }= dwValue;  /* bitwise xor operation */
  }
  dwValue = GetThreadStartAddress(theOP->threadID);
  dwValue = ModuleOffset(dwValue);
  fpResult \hat{ }= dwValue;  /* bitwise xor operation */
  return fpResult;
}
```

Note that since call stack information is needed to calculate a fingerprint, no fingerprint can be calculated if call stacks are unavailable. However, in the tested embodiment of the Performance Evaluator, recording call stacks is optional. For example, in this tested embodiment, the user was provided with the capability to disable it for storing a longer period of trace data in the circular buffer. The information of start address of the current thread may or may not be included in the call stack since OPInfo structure contains a static array field to store the call stack of an operation. The depth of the recorded call stack is limited. In the pseudo code illustrated in Table 5, the Performance Evaluator uses a simple bitwise XOR operation to summarize all information into a DWORD value since in the tested embodiment of the Performance Evaluator, potential collision of fingerprints was not considered to be a critical issue. However, in an alternate embodiment, a strong hash algorithm, such as MD5, for example, can be used to calculate a fingerprint to ensure that there are no collisions between fingerprints, thereby making root cause detection more robust when using fingerprints.

3.0 Operational Summary of the Performance Evaluator:

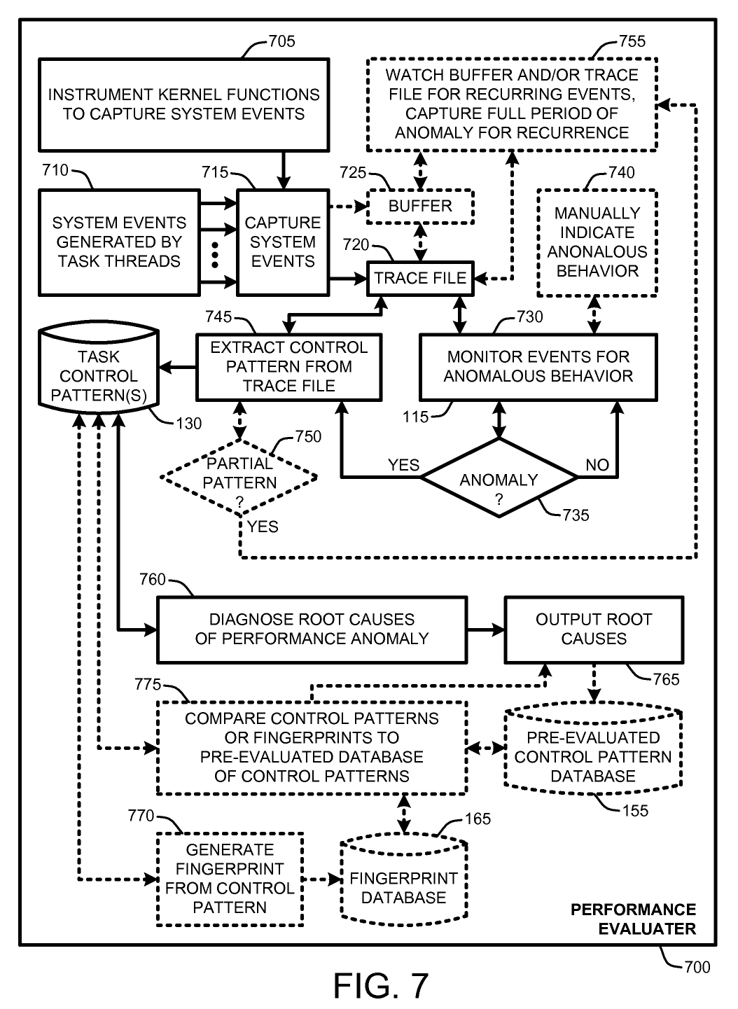

The processes described above with respect to FIG. 1 through FIG. 6, and in further view of the detailed description provided above in Section 1 and Section 2 are summarized by the general operational flow diagram of FIG. 7. In particular, FIG. 7 provides an exemplary operational flow diagram that illustrates operation of some of the various embodiments of the Performance Evaluator described above. Note that FIG. 7 is not intended to be an exhaustive representation of all of the various embodiments of the Performance Evaluator described herein, and that the embodiments represented in FIG. 7 are provided only for purposes of explanation.

Further, it should be noted that any boxes and interconnections between boxes that may be represented by broken or dashed lines in FIG. 7 represent optional or alternate embodiments of the Performance Evaluator described herein. Any or all of these optional or alternate embodiments, as described below, may be used in combination with other alternate embodiments that are described throughout this document.

In general, as illustrated by FIG. 7, the Performance Evaluator 700 begins operation by instrumenting 705 various kernel functions to capture system events and inter-thread interactions corresponding to one or more active tasks or applications. The Performance Evaluator 700 then captures 715 those system events and inter-thread interactions and stores them to a trace file 720, either directly, or via a buffer 725. As discussed above, in various embodiments, the buffer 725 can be either fixed or variable size. In fixed-size buffer embodiments, the buffer 725 is generally configured as a circular buffer.

In either case, in various embodiments, the Performance Evaluator 700 monitors 730 the trace file 720 for events thread behaviors that indicate anomalous task behavior (such as, for example, delays in thread completion or other thread failures). If an anomaly is observed 735, then the Performance Evaluator 700 extracts 745 a control pattern from the trace file and stores that control pattern 130 for further evaluation. If an anomaly is not observed 735, the Performance Evaluator 700 simply continues to monitor 730 the trace file 720 until such time as an anomaly is observed, or the operation of the Performance Evaluator 700 is terminated.

Note that as discussed above, in various embodiments, the user is provided with a user interface for manually indicating 745 anomalous task or application behavior. A simple example would be a case where the user feels that a particular task or program has not responded within a reasonable time. The user will then use the user interface to trigger the Performance Evaluator 700 to begin processing the data in the trace file 720. In this case, the Performance Evaluator 700 responds in the same manner as if it had observed anomalous behavior via monitoring 730 of the trace file by extracting 745 a control pattern from the trace file.

In either case, once the control pattern 130 has been extracted 745 from the trace file 720, the Performance Evaluator 700 evaluates the stored control pattern 130 to diagnose 760 the one or more root causes of the performance anomaly. The Performance Evaluator 700 then outputs 765 the root causes via a user interface, or stores those root causes to the pre-evaluated control pattern database 155 for later use or comparison to subsequently generated control patterns.

As noted above, abnormal program or task termination can occur for a number of reasons. In such cases, the trace file 720 (or buffer 725) may contain only a partial record of any anomalous behavior that was occurring at the time of the abnormal termination. Further, in the case that the buffer 725 is too small, the trace file may again contain only a partial record of any anomalous behavior at the time that the buffer filled up. In either case, the control pattern extracted 745 from the trace file 720 will be a “partial control pattern.”

In various embodiments, the Performance Evaluator 700 monitors the extraction process for partial control patterns. Then, when a partial control pattern is observed 750, the Performance Evaluator 700 sets a watch 755 on the buffer and/or the trace file to look for a recurrence of events matching those of the partial control pattern. Then, whenever the Performance Evaluator 700 observes matching events in the trace file 720 or the buffer 725, the Performance Evaluator ensures that additional system event data is captured and stored to the trace file in order to cover the entire period of the anomalous behavior. Then, a more complete, or full control pattern will be extracted 745 from the trace file 720.

As noted above, particular performance anomalies may recur on a particular system, or may happen on similar computers using similar operating systems. Therefore, in various embodiments, rather than evaluate every control pattern to diagnose 760 the root cause of the performance anomaly, the Performance Evaluator 700 instead compares 775 the full or partial control pattern 130 to entries in the pre-evaluated control pattern database 155. Then, if a match is found, the root causes, and possible solution, to the matching control pattern is output 765.

Finally, in various embodiments, the Performance Evaluator 700 generates 770 fingerprints from full or partial control patterns 130. These fingerprints are then stored to a fingerprint database 165, and compared 775 to fingerprints in the pre-evaluated control pattern database 155 to determine whether matching fingerprints exist. If the comparison 775 locates a matching fingerprint, then the root causes of the performance anomaly corresponding to the control pattern associated with the match fingerprint are output 765, as described above.

4.0 Exemplary Operating Environments:

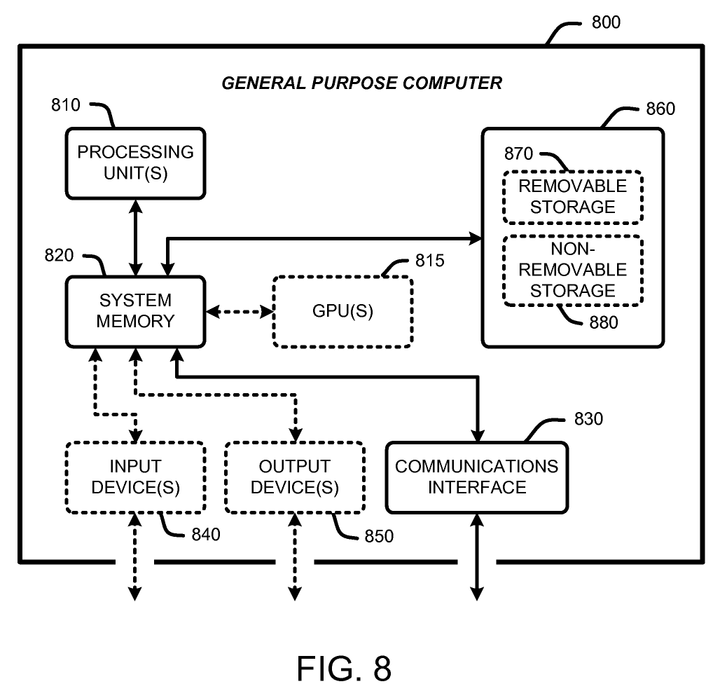

The Performance Evaluator is operational within numerous types of general purpose or special purpose computing system environments or configurations. FIG. 8 illustrates a simplified example of a general-purpose computer system on which various embodiments and elements of the Performance Evaluator, as described herein, may be implemented. It should be noted that any boxes that are represented by broken or dashed lines in FIG. 8 represent alternate embodiments of the simplified computing device, and that any or all of these alternate embodiments, as described below, may be used in combination with other alternate embodiments that are described throughout this document.

For example, FIG. 8 shows a general system diagram showing a simplified computing device. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, video media players, etc.

At a minimum, to allow a device to implement the Performance Evaluator, the device must have some minimum computational capability along with some internal storage capability for storing and evaluating trace data (or a data output device or network connection for external storage and evaluation of trace data).

In particular, as illustrated by FIG. 8, the computational capability is generally illustrated by one or more processing unit(s) 810, and may also include one or more GPUs 815. Note that that the processing unit(s) 810 of the general computing device may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 8 may also include other components, such as, for example, a communications interface 830. The simplified computing device of FIG. 8 may also include one or more conventional computer input devices 840. The simplified computing device of FIG. 8 may also include other optional components, such as, for example, one or more conventional computer output devices 850. Finally, the simplified computing device of FIG. 8 may also include storage 860 that is either removable 870 and/or non-removable 880. Note that typical communications interfaces 830, input devices 840, output devices 850, and storage devices 860 for general-purpose computers are well known to those skilled in the art, and will not be described in detail herein.

The foregoing description of the Performance Evaluator has been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate embodiments may be used in any combination desired to form additional hybrid embodiments of the Performance Evaluator. It is intended that the scope of the invention be limited not by this detailed description, but rather by the claims appended hereto.

What is claimed is:

1. A system for constructing control patterns for use in diagnosing root causes of performance problems in applications, comprising:
a device for monitoring events and inter-thread interactions of a task during execution of the task using instrumentation techniques;
a device for recording trace data including the events and inter-thread interactions of the task for a period of interest; and
a device for evaluating the recorded trace data to construct control patterns, said control patterns including identifications of all critical participant threads and causal relations of operations that happened in those threads during the period of interest.

2. The system of claim 1 wherein the instrumentation techniques further comprise a device for instrumenting a set of kernel functions for collecting the trace data for the task.

3. The system of claim 1 further comprising a device for evaluating the control patterns to determine one or more root causes of a performance problem that occurred during the execution of the task.

4. The system of claim 3 wherein evaluating the recorded trace data to construct the control patterns further comprises:
identifying as “significant operations” all operations represented in the trace data whose duration exceed a predetermined operation time threshold;
recursively evaluating all significant operations to identify all causal operations of each significant operation; and
determining a total period of delay for each causal operation.

5. The system of claim 4 wherein determining the root causes as being responsible for the performance problem further comprises:
identifying the causal operation being responsible for the largest total period of delay as a root cause; and
identifying one or more additional causal operations if there are other large delay periods which are not covered in the largest total period of delay.

6. The system of claim 1 further comprising:
comparing one or more of the control patterns to a database of pre-evaluated control patterns to determine whether a match to the control patterns is in the database, said database including one or more root causes of performance problems for each pre-evaluated control pattern in the database; and
outputting root causes of any performance problem corresponding to a match to the control patterns.

7. The system of claim 1 where the recorded trace data contains only a partial control pattern, and further comprising:
comparing the partial control pattern with control patterns constructed from subsequently recorded trace data; and
wherein if the partial control pattern matches a control pattern from subsequently recorded trace data, the matched control pattern from the subsequently recorded trace data is further evaluated to diagnose one or more root causes of a performance problem that occurred during the execution of the task.

8. The system of claim 1 further comprising:
constructing a first control pattern fingerprint for one or more of the control patterns or partial control patterns;
comparing the first control pattern fingerprint to a database of control pattern fingerprints to determine whether there is a match to the first control pattern fingerprint; and
outputting root causes of any performance problem corresponding to the any match to the first control pattern fingerprint.

9. A method for constructing control patterns for use identifying critical participant threads and causal relations of operations during execution of an application, comprising steps for:
using instrumentation elements to monitor events and inter-thread interactions associated with a task during execution of the task;
identifying a period of interest during execution of the task;
recording trace data including the events and inter-thread interactions of the task for the period of interest;
constructing one or more control patterns from the recorded trace data, said control patterns including identifications of all critical participant threads and causal relations of operations that happened in those threads during the period of interest; and
evaluating the control patterns to determine one or more root causes of a performance problem that occurred during the execution of the task.

10. The method of claim 9 wherein the instrumentation elements include steps for instrumenting a set of kernel functions for collecting the trace data for the task during the period of interest.

11. The method of claim 9 wherein constructing the control patterns from the recorded trace data further comprises:
identifying as “significant operations” all operations represented in the trace data whose duration exceed a predetermined operation time threshold;
recursively evaluating all significant operations to identify all causal operations of each significant operation; and
determining a total period of delay for each causal operation.

12. The method of claim 11 wherein determining the root causes as being responsible for the performance problem further comprises:
identifying the causal operation being responsible for the largest total period of delay as a root cause; and
identifying one or more additional causal operations as additional root causes if those causal operations have corresponding delay periods which are longer than a predetermined threshold and which are not covered in the largest total period of delay.

13. The method of claim 9 further comprising:
comparing one or more of the control patterns to a database of pre-evaluated control patterns to determine whether a match to the control patterns is in the database, said database including one or more root causes of performance problems for each pre-evaluated control pattern in the database; and
outputting root causes of any performance problem corresponding to a match to the control patterns.

14. The method of claim 9 wherein the recorded trace data contains only enough information to construct a partial control pattern, and further comprising:
comparing the partial control pattern with control patterns constructed from subsequently recorded trace data; and
wherein if the partial control pattern matches a control pattern from the subsequently recorded trace data, the matched control pattern from the subsequently recorded trace data is further evaluated to diagnose one or more root causes of the performance problem that occurred during the execution of the task.

15. The method of claim 9 wherein starting the recording of the trace data for the period of interest is manually triggered via a user interface.

16. A computer-readable medium having computer-executable instructions stored thereon for diagnosing root causes of performance problems in applications, said instructions comprising:
buffering system-level and application-level trace data including events and inter-thread interactions related to execution of a particular task;
automatically initiating a recording of the trace data, including any buffered trace data whenever any operation associated with the task does not complete within a predetermined time period;
constructing one or more control patterns from the recorded trace data, said control patterns including identifications of all critical participant threads and causal relations of operations that happened in those threads during the period of interest; and
evaluating the control patterns to determine one or more root causes of a performance problem that occurred during the execution of the task.

17. The computer-readable medium of claim 16 wherein the recording is manually initiated via a user interface when a user suspects that a performance anomaly is occurring, whether or not any operation associated with the task does not complete within the predetermined time period.

18. The computer-readable medium of claim 16 wherein constructing the control patterns from the recorded trace data further comprises:
identifying as “significant operations” all operations represented in the trace data whose duration exceed a predetermined operation time threshold;
recursively evaluating all significant operations to identify all causal operations of each significant operation; and
determining a total period of delay for each causal operation.

19. The computer-readable medium of claim 18 wherein determining the root causes as being responsible for the performance problem further comprises:
identifying the causal operation being responsible for the largest total period of delay as a root cause; and
identifying one or more additional causal operations as additional root causes if those causal operations have corresponding delay periods which are longer than a predetermined threshold and which are not covered in the largest total period of delay.

20. The computer-readable medium of claim 16 wherein the recorded trace data contains only enough information to construct a partial control pattern, and further comprising:
comparing the partial control pattern with control patterns constructed from subsequently recorded trace data; and
wherein if the partial control pattern matches a control pattern from the subsequently recorded trace data, the matched control pattern from the subsequently recorded trace data is further evaluated to diagnose one or more root causes of the performance problem that occurred during the execution of the task.
